(19) United States
(12) Patent Application Publication
(10) Pub. No.: US 2026/0284719 A1
(43) Pub. Date: Sep. 24, 2026

(54) SYSTEM FOR CLEANING AN ICE MAKING ASSEMBLY FOR A REFRIGERATOR APPLIANCE

(71) Applicant: Haier US Appliance Solutions, Inc., Wilmington, DE (US)

(72) Inventor: Alan Joseph Mitchell, Louisville, KY (US)

(21) Appl. No.: 19/084,845

(22) Filed: Mar. 20, 2025

(51) Int. Cl. B08B 9/032; B08B 13/00; F25C 1/147

(52) U.S. Cl. CPC B08B 9/0321; B08B 13/00; B08B 2209/032; F25C 1/147; F25C 2400/12; F25C 2700/04

(57) ABSTRACT

A refrigerator appliance includes a cabinet that defines a chilled chamber. The refrigerator appliance includes a primary conduit coupled with the cabinet and an ice making assembly disposed within the chilled chamber. The ice making assembly includes a base coupled with the cabinet and an ice forming assembly coupled with the base. The ice making assembly includes a reservoir fluidly coupled with the primary conduit and the ice forming assembly. The ice making assembly includes an ice tray coupled with the ice forming assembly. The ice tray defines a drain. A is tank removably coupled with the cabinet. The tank is configured to receive liquid from the drain. A pump is fluidly coupled with the tank and the reservoir. The pump flows liquid from the tank to the reservoir.

### FIELD OF THE INVENTION

The present subject matter relates generally to refrigerator appliances, and more particularly to ice making assemblies for a refrigerator appliance.

### BACKGROUND OF THE INVENTION

Refrigerator appliances generally include a cabinet that defines one or more chilled chambers for receipt of food articles for storage. Typically, one or more doors are rotatably hinged to the cabinet to permit selective access to food items stored in the chilled chamber. Further, refrigerator appliances commonly include ice making assemblies mounted within an icebox on one of the doors or in a freezer compartment or even a fresh food compartment. The ice is stored in a storage bin and is accessible from within the freezer chamber, the fresh food compartment, or may be discharged through a dispenser recess defined on a front of the refrigerator door.

Ice making assemblies located in the fresh food compartment may experience a relatively slow melting process of the ice stored therein compared to exposed ice making assemblies. Melted ice, or water, can cause undesirable sediments to precipitate out or even undesirable lifeforms, such as bacteria or fungi, to exist. Current systems may have limited, if any, options to clean out said sediments and lifeforms.

Accordingly, a refrigerator appliance with features for improved operation of ice making assemblies would be desirable. More particularly, an ice making assembly that includes features to facilitate versatile and efficient cleaning of the ice making assembly would be particularly beneficial.

### BRIEF DESCRIPTION OF THE INVENTION

Aspects and advantages of the invention will be set forth in part in the following description, may be apparent from the description, or may be learned through practice of the invention.

In one example embodiment, A refrigerator appliance includes a cabinet that defines a chilled chamber. The refrigerator appliance includes a primary conduit coupled with the cabinet and an ice making assembly disposed within the chilled chamber. The ice making assembly includes a base coupled with the cabinet and an ice forming assembly coupled with the base. The ice making assembly includes a reservoir fluidly coupled with the primary conduit and the ice forming assembly. The ice making assembly includes an ice tray coupled with the ice forming assembly. The ice tray defines a drain. A is tank removably coupled with the cabinet. The tank is configured to receive liquid from the drain. A pump is fluidly coupled with the tank and the reservoir. The pump flows liquid from the tank to the reservoir.

In another example embodiment, a system of operating an ice making assembly is for a refrigerator. The system includes an ice making assembly that includes a base coupled with a cabinet of the refrigerator and an ice forming assembly coupled with the base. A reservoir is fluidly coupled with a primary conduit of the refrigerator. The reservoir is also fluidly coupled with the ice forming assembly. An ice tray is coupled with the ice forming assembly. The ice tray defines a drain. A tank is removably coupled with the cabinet. The tank is configured to receive liquid from the drain. A pump is fluidly coupled with the tank and the reservoir. The pump flows liquid from the tank to the reservoir. A controller is configured to selectively activate the pump to cycle liquid through the reservoir, the ice forming assembly, the ice tray, the drain, the tank, and the pump.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an example embodiment of the present subject matter.

FIG. 2 provides a front view of the example refrigerator appliance of FIG. 1, with the doors of the fresh food chamber and freezer chamber shown in an open position.

FIG. 3 provides a side cross-sectional view of the example refrigerator appliance and an example ice making assembly of FIG. 1 according to an example embodiment of the present subject matter.

FIG. 4 provides another side cross-sectional view of the example refrigerator appliance and an example ice making assembly of FIG. 1 according to an example embodiment of the present subject matter.

FIG. 5 provides another side cross-sectional view of the example refrigerator appliance and an example ice making assembly of FIG. 1 according to an example embodiment of the present subject matter.

FIG. 6 provides a perspective view of the example refrigerator appliance and an example ice making assembly of FIG. 1 according to an example embodiment of the present subject matter.

FIG. 7 provides another side cross-sectional view of the example refrigerator appliance and an example ice making assembly of FIG. 1 having a flow path according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

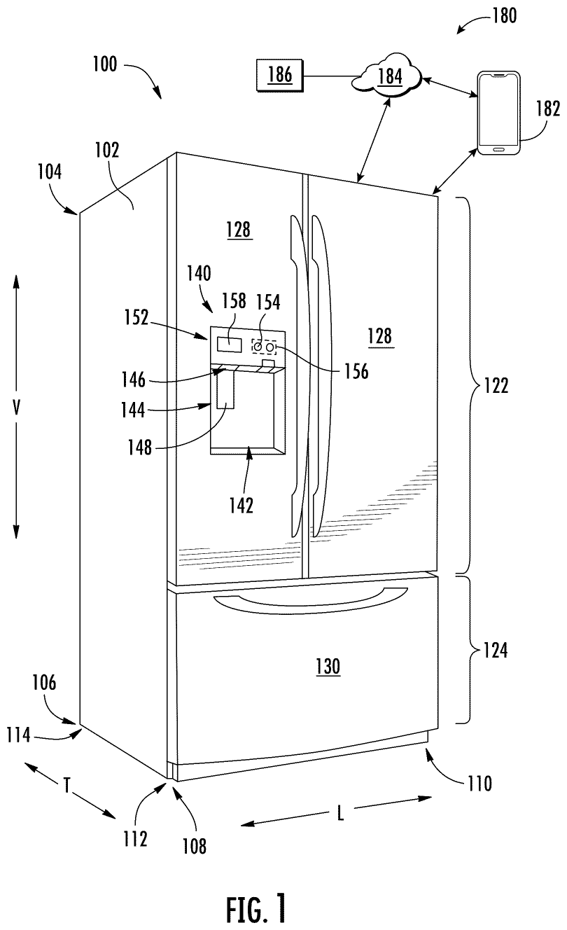

FIG. 1 provides a perspective view of a refrigerator appliance 100 according to an exemplary embodiment of the present subject matter. Refrigerator appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Cabinet 102 defines chilled chambers for receipt of food items for storage. In particular, cabinet 102 defines fresh food chamber 122 positioned at or adjacent top 104 of cabinet 102 and a freezer chamber 124 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well, such as other appliances including fluid dispensers. Consequently, the description set forth herein is for illustrative purposes only and is not intended to be limiting in any aspect to any particular appliance or configuration.

Refrigerator doors 128 are rotatably hinged to an edge of cabinet 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. To prevent leakage of cool air, refrigerator doors 128, freezer door 130, and/or cabinet 102 may define one or more sealing mechanisms (e.g., rubber gaskets, not shown) at the interface where the doors 128, 130 meet cabinet 102. It should be appreciated that doors having a different style, position, or configuration are possible within the scope of the present subject matter.

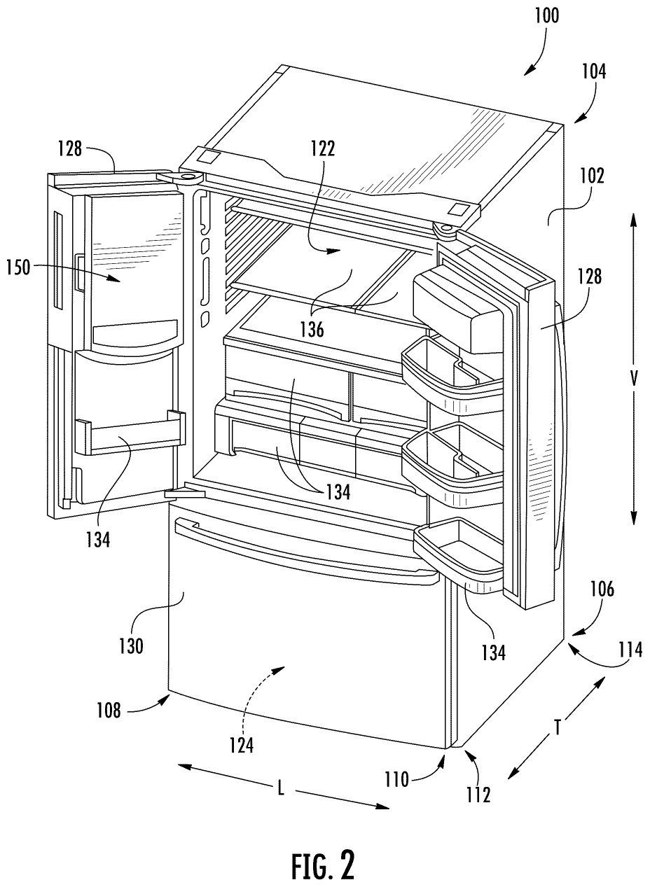

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, an indicator 158, such as a display, a screen, a speaker, a light, etc., may be provided on control panel 152. The indicator 158 may be in communication with controller 156, and may generate an indicia in response to signals from controller 156. For example, the indicia generated by the indicator 158 may include a written message on a display, a chime from a speaker, a specific color (e.g., green or red) from a light or LED, or the like.

As used herein, “processing device” or “controller” may refer to one or more microprocessors or semiconductor devices and is not restricted necessarily to a single element. The processing device can be programmed to operate refrigerator appliance 100, dispensing assembly 140, an ice making assembly 200 (described in more detail below), and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 180 will be described according to an exemplary embodiment of the present subject matter. In general, external communication system 180 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 180 may be used to transfer data or other information to improve performance of one or more external devices or appliances and/or improve user interaction with such devices.

For example, external communication system 180 permits controller 156 of refrigerator appliance 100 to communicate with a separate device external to refrigerator appliance 100, referred to generally herein as an external device 182. As described in more detail below, these communications may be facilitated using a wired or wireless connection, such as via a network 184. In general, external device 182 may be any suitable device separate from refrigerator appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with refrigerator appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control refrigerator appliance 100, etc. In addition, external device 182 and remote server 186 may communicate with refrigerator appliance 100 to communicate similar information.

In general, communication between refrigerator appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with refrigerator appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

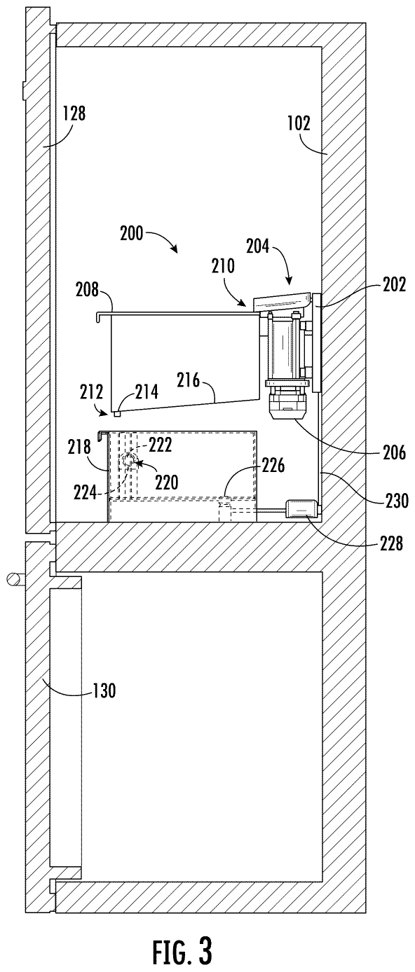

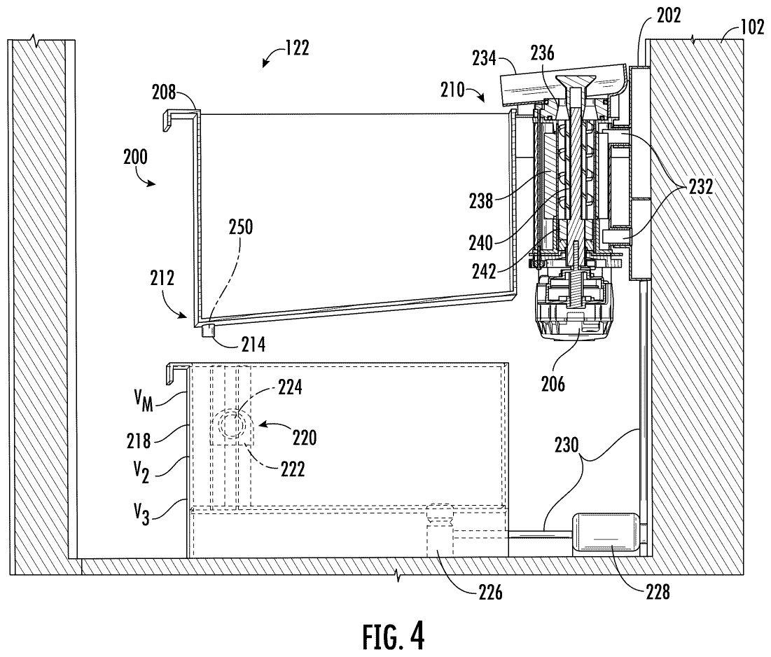

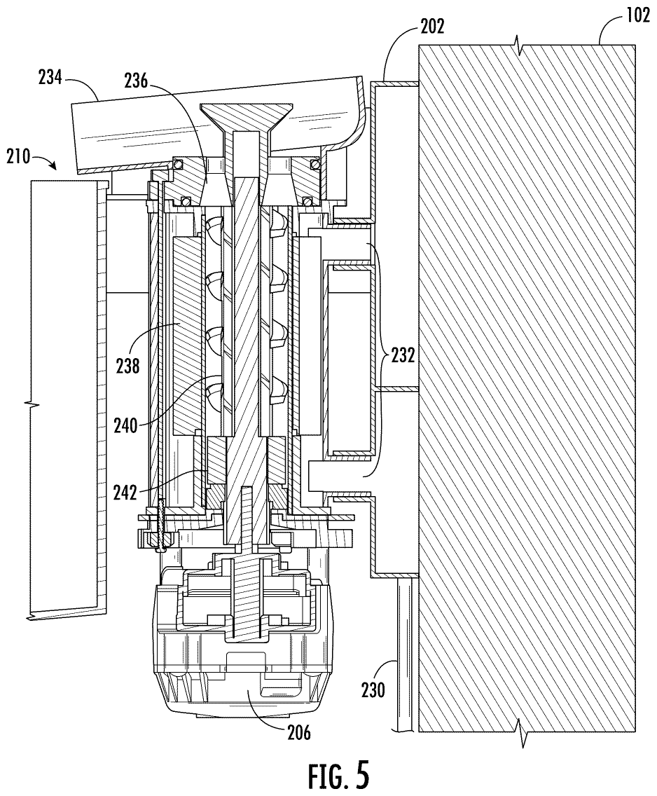

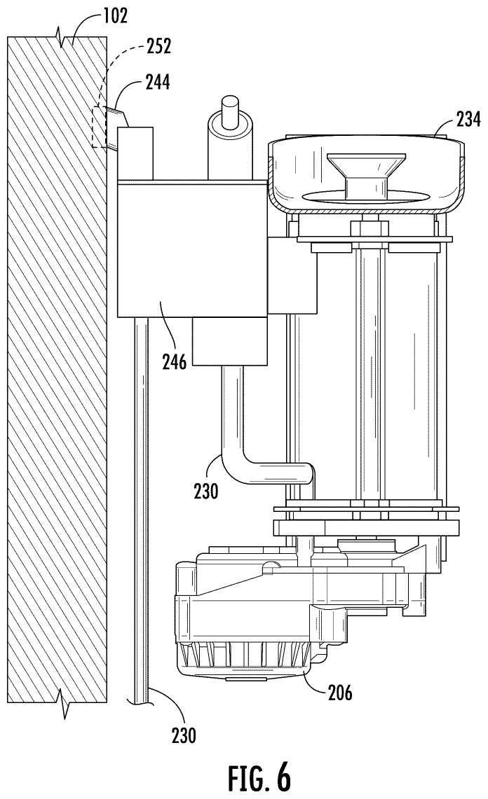

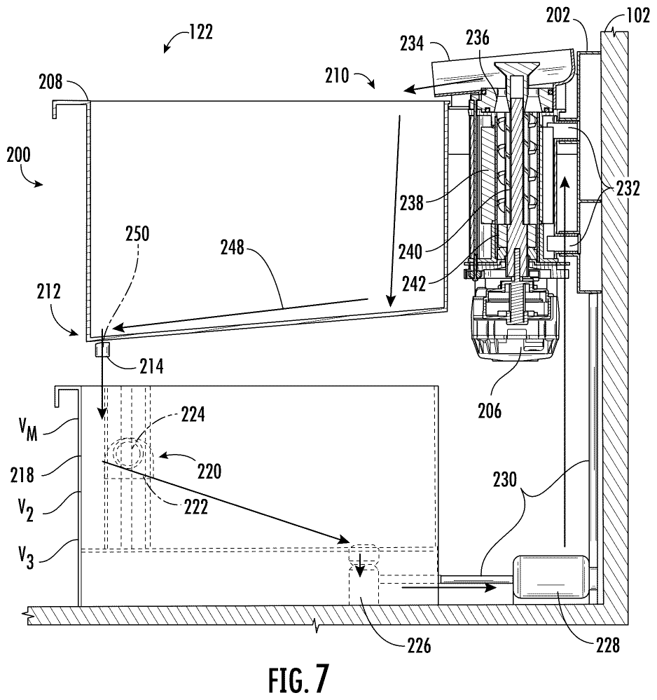

With reference to FIGS. 3 through 7, the refrigerator appliance 100 includes an ice making assembly 200 disposed within the cabinet 102. More specifically, the ice making assembly 200 may be disposed within the fresh food chamber 122. Thus, ice produced and stored by the ice making assembly 200 may be subject to higher-than-freezing temperatures. However, a temperature of the fresh food chamber 122 may be greater than a freezing temperature by less than about 30%, less than about 25%, less than 15%, or even less than about 10%; therefore, melting of the ice stored by the ice making assembly 200 may occur relatively slowly compared to an ice making assembly that is exposed to ambient temperatures within a home, for example.

The ice making assembly 200 includes a base 202. The base 202 is coupled with the cabinet 102. The base 202 may include a bracket that is directly coupled with the cabinet 102. The ice making assembly 200 further includes a cold air duct 232 coupled with at least one of the cabinet 102 and the base 202. The cold air duct 232 may be fluidly coupled with, for example, a condenser (not shown), a compressor (not shown), and a condenser fan (not shown) to move cold air to the ice making assembly 200. The ice making assembly 200 also include a primary conduit 244 configured to deliver liquid water from, for example, a municipal water supply (not shown) to the ice making assembly 200. Furthermore, the ice making assembly 200 may include a primary valve 252 fluidly coupled with the primary conduit 244 to selectively allow, or restrict, liquid flowing from the primary conduit 244. More specifically, the ice making assembly 200 may include a reservoir 246 coupled with the base 202, for example, where the primary conduit 244 may be fluidly coupled with the reservoir 246, such that liquid water is selectively poured into the reservoir 246.

Furthermore, the ice making assembly 200 includes an ice forming assembly 204 generally coupled with the base 202. The ice forming assembly 204 may be where liquid water (from the reservoir 246) is converted into solid ice and formed into cubes, nuggets, or another convenient shape and size for a user (e.g., cocktail ice). The ice forming assembly 204 may be at least partially circumferentially surrounded by the cold air duct 232. The ice forming assembly 204 includes a cylinder 242 that may be disposed within the cold air duct 232. Further, the cylinder 242 may be fluidly coupled with the reservoir 246. Specifically, the cylinder 242 may be fluidly coupled with the reservoir 246 via an auxiliary conduit 230. For example, the auxiliary conduit 230 may extend from a bottom of the reservoir 246 to a bottom of the cylinder 242 through the cold air duct 232. The ice forming assembly 204 further includes a heat exchanger 238 positioned circumferentially around the cylinder 242. The heat exchanger 238 may include, for example, evaporator coils, a cold plate, or the like to draw heat from the cylinder 242 holding the water. The heat exchanger 238 may be cooled by air delivered from the cold air duct 232. Liquid water within the cylinder 242 may be cooled to the point of freezing into solid ice within the cylinder 242. The ice forming assembly 204 may further include an auger 240 configured to break up solid ice and move said solid ice out of the cylinder 242. For example, the auger 240 may be cork-screw-shaped and rotate to break up the solid ice and move it vertically up and out of the cylinder 242. The ice forming assembly 204 may further include an extruder 236, or narrowing conical tube, that shapes the solid ice into nuggets, pellets, or the like. The ice forming assembly 204 may include a motor 206 operably coupled with the auger 240. The motor 206 may be communicatively coupled with the controller 156. The motor 206 may selectively rotate the auger 240 in response to receiving instructions to do so by the controller 156. For example, the ice forming assembly 204 may include a drive shaft (not labeled) that is coupled with both the auger 240 and the motor 206, such that the motor 206 rotates the drive shaft which in turn rotates the auger 240.

The ice making assembly 200 further includes a chute 234 coupled with the extruder 236 of the ice forming assembly 204. The chute 234 may receive the solid ice nuggets. The ice making assembly 200 further include a tray 208, or ice tray, positioned adjacent to and vertically lower than the chute 234. The chute 234 may be configured to receive the solid ice from the extruder 236 and deliver the solid ice to the tray 208. For example, the chute 234 may be sloped toward the tray 208. The tray 208 may be removably coupled with the cabinet 102 via at least one track (not shown), for example. Additionally, or alternatively, the ice making assembly 200 may include an ice level sensor (not shown) that may activate or deactivate the ice forming assembly 204 based on a quantity of solid ice stored in the tray 208. For example, the tray 208 may hold a first quantity of ice, or max quantity of ice, that deactivates the ice forming assembly 204.

The tray 208 may include a handle (not labeled) to assist a user in removing and placing the tray 208 back next to the chute 234 of the ice forming assembly 204. The tray 208 may have a first portion 210, or first side, positioned adjacent, or proximal, to the chute 234. The first portion 210 may include a rear transverse half of the tray 208. Further, the tray 208 includes a second portion 212, or second side, positioned distal the chute 234. The second portion 212 may include a front transverse half of the tray 208. Therefore, the first portion 210 and the second portion 212 may be distinguished by generally bisecting the tray 208 into two transverse halves where the front half is the second portion 212 and the rear half is the first portion 210. The tray 208 may include a sloped bottom 216 that slopes vertically down from the first portion 210 to the second portion 212. Furthermore, the tray 208 defines a drain 214. More specifically, the second portion 212 may define the drain 214 such that the solid ice that melts into liquid water allows the liquid water to flow along the sloped bottom 216 toward the drain 214. Additionally, or alternatively, the tray 208 may include a drain valve 250 fluidly coupled with the drain 214 to selectively allow liquid to flow through the drain 214. For example, the drain valve 250 may be communicatively coupled with the controller 156. The controller 156 may instruct the drain valve 250 to close, or not let liquid flow through the drain 214 if a tank 218 has been removed, or is not present.

The ice making assembly 200 further includes the tank 218, or melt collection tank, removably coupled with the cabinet 102. The tank 218 may rest atop the cabinet 102 within the fresh food chamber 122, for example. Additionally, or alternatively, the cabinet 102 may include, or define, a second track (not shown) that allows the tank 218 to slidably couple with the cabinet 102. Similar to the tray 208, the tank 218 may include a handle (not labeled) that assists a user in removing or placing back the tank 218. The tank 218 is positioned vertically beneath the drain 214 such that liquid, affected by gravity, may flow from the tray 208, through the drain valve 250, through the drain 214, and into the tank 218.

The ice making assembly 200 further includes a water level sensor assembly 220 configured to detect a volume of liquid held within the tank 218. The water level sensor assembly 220 is communicatively coupled with the controller 156. For example, the water level sensor assembly 220 may transmit a signal to the controller 156, and the controller 156 may then determine a volume of liquid held within the tank 218. The water level sensor assembly 220 may include, for example, a floating magnet 224 disposed within the tank 218 that rises and falls as a volume of liquid in tank 218 changes. The water level sensor assembly 220 may also include one or more sensors 222 that include a Reed switch, a Hall Effect sensor, a magnetoresistive sensor, or the like that are tripped by the floating magnet 224 at one or more levels (e.g., one or more volumes). The water level sensor assembly 220 may include other sensor assemblies to detect change in volume such as a hydrostatic pressure sensor, a capacitive sensor, ultrasonic sensor, radio sensor, and the like.

The water level sensor assembly 220 may detect when the volume of liquid held within the tank 218 reaches a max volume Vm. The max volume Vm may be predetermined by the manufacturer, designer, retailer, or user of the refrigerator appliance 100. For example, the max volume Vm may correspond to the tank 218 holding a volume of liquid that occupies about 90% of the available volume within the tank 218. Additionally, or alternatively, the max volume Vm may correspond to about 80%, about 70%, or about 60% of the available volume within the tank 218. Additionally, or alternatively, the water level sensor assembly 220 may detect when the volume of liquid held within the tank 218 reaches multiple volumes including, for example, a second volume V2 and a third volume V3. The second volume V2 and the third volume V3 may be less than the max volume Vm. Additionally, or alternatively, the second volume V2 and the third volume V3 may correspond to volumes where a check valve 226 is submerged.

The ice making assembly 200 may include the check valve 226 within the tank 218. The check valve 226 may be open, or allow flow, if the tank 218 is present. Furthermore, the check valve 226 may close, or restrict flow, if the tank 218 is removed. The ice making assembly 200 may include additional valves that may be communicatively coupled with the controller 156. For example, the controller 156 may selectively shut an electronic valve (not shown) if the tank 218 is removed. Additionally, or alternatively, a second check valve (not shown) may statically allow liquid to flow out of the tank 218 through the second check valve while restricting liquid from flowing into the tank 218 through the second check valve.

The ice making assembly 200 further includes a pump 228 fluidly coupled with the check valve 226. The pump 228 may also be fluidly coupled with the reservoir 246. For example, the auxiliary conduit 230 may fluidly couple the check valve 226 with the pump 228 and the pump 228 with the reservoir 246. Additionally, or alternatively, The auxiliary conduit 230 extending between the pump 228 and the reservoir 246 may enter the reservoir 246 at an air gap (not shown) such that water, or liquid, is not siphoned out of the reservoir 246 to the tank 218. The pump 228 is communicatively coupled with the controller 156. For example, the controller 156 may activate the pump 228 for a first period of time to cycle water through the ice making assembly 200. Additionally, or alternatively, the controller 156 may activate the pump 228 for a second period of time to cycle a cleaning solution through the ice making assembly 200.

The controller 156 may begin a rinsing cycle in response to the water level sensor assembly 220 detecting the volume held within the tank 218 is at the max volume Vm. The controller 156 may generate a first indicia at the indicator 158 that alerts a user the tank 218 is holding the max volume Vm of liquid, or melt water. The first indicia may include a message or alert that prompts the user to remove the tank 218, dump out, or empty, the melt water from the tank 218, and place the tank 218 back vertically beneath the drain 214. The user may interact with the inputs 154, or user input device, or the external device 182 to send a signal to the controller 156 that allows the controller 156 to determine the tank 218 is empty, or has been emptied. Additionally, or alternatively, the water level sensor assembly 220 may signal to the controller 156 that the floating magnet 224 is back, and the controller 156 may then determine the tank 218 is replaced and emptied. The controller 156 may instruct the primary valve 252 to flow water into the reservoir 246. Additionally, or alternatively, the controller 156 may instruct the primary valve 252 to restrict water flowing through the primary conduit 244 in response to the water level sensor assembly detecting the liquid held within the tank 218 is at the second volume V2. Additionally, or alternatively, the controller 156 may instruct the check valve 226 to open and the pump 228 to recirculate the melt water from the tank 218 to the reservoir 246 to make recycled solid ice. The ice making assembly 200 may recycle the melt water and recycled ice for a predetermined recirculation period of time, for example, about 90 days, about 75 days, about 60 days, or even about 30 days. After the predetermined recirculation period of time, the controller 156 may generate the first indicia.

The controller 156 may activate the pump 228 to flow liquid (e.g., water or the cleaning solution) to flow along a flow path 248 that includes flowing through the pump 228, through the auxiliary conduit 230 connecting the pump 228 and the reservoir 246, through the reservoir 246, through the auxiliary conduit 230 connecting the reservoir 246 with the cylinder 242 of the ice forming assembly 204, through the extruder 236 of the ice forming assembly 204, out the chute 234, into the tray 208, over the sloped bottom 216 of the tray 208, through the drain valve 250, through the drain 214, into the tank 218, through the check valve 226, and back through the pump 228. The first period of time during which the pump 228 is activated may correspond to cycling fresh water through the flow path for about 20 minutes or less, fewer than about 15 minutes, fewer than about 10 minutes, or even fewer than about 5 minutes. The controller 156 may activate the pump 228 for the first period of time in response to the volume of liquid held within the tank 218 being at the second volume V2.

Further, the controller 156 may begin a cleaning cycle by generating a second indicia at the indicator 158 that alerts a user the tank 218 to add a cleaning solution to the tank 218, or elsewhere along the flow path 248. Additionally, or alternatively, the second indicia may include a message or alert that prompts the user to remove the tank 218, dump out, or empty, the fresh water from the tank 218, and place the tank 218 back vertically beneath the drain 214 prior to adding the cleaning solution. The user may interact with the inputs 154, or user input device, or the external device 182 to send a signal to the controller 156 that allows the controller 156 to determine the tank 218 is empty, or has been emptied. Additionally, or alternatively, the user may interact with the inputs 154 or external device 182 to send a signal to the controller 156 that allows the controller 156 to determine the cleaning solution has been added to the tank 218, or along the flow path 248. Additionally, or alternatively, the water level sensor assembly 220 may signal to the controller 156 that the floating magnet 224 is back, and the controller 156 may then determine the tank 218 is replaced and emptied.

The controller 1556 may instruct the primary valve 252 flow water into the reservoir 246. Additionally, or alternatively, the controller 156 may instruct the primary valve 252 to restrict water flowing through the primary conduit 244 in response to the water level sensor assembly detecting the liquid held within the tank 218 is at the third volume V3.

The controller 156 may activate the pump 228 for a second period of time to allow the cleaning solution to cycle through the flow path. The second period of time, similar to the first period of time, may correspond to cycling the cleaning solution through the flow path for about 20 minutes or less, fewer than about 15 minutes, fewer than about 10 minutes, or even fewer than about 5 minutes. Furthermore, the controller 156 may iteratively cycle the ice making assembly 200 through the rinsing cycle and the cleaning cycle. Additionally, or alternatively, the controller 156 may activate the motor 206 during at least one of the first period of time and the second period time to assist in rinsing or cleaning the auger 240.

Advantageously, the system described herein allows an ice making assembly of a refrigerator to be thoroughly rinsed and cleaned. Regularly activating the rinse cycle and the cleaning cycle at least as often as the tank reaches a max volume allows the ice making assembly to avoid building up large amounts of sediments or undesirable lifeforms. Thus, the solid ice may contain fewer undesirables compared to systems without the presently described system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction, a lateral direction, and a transverse direction, comprising:
a cabinet defining a chilled chamber;
a primary conduit coupled with the cabinet;
an ice making assembly disposed within the chilled chamber, the ice making assembly comprising:
a base coupled with the cabinet;
an ice forming assembly coupled with the base;
a reservoir fluidly coupled with the primary conduit and the ice forming assembly;
an ice tray coupled with the ice forming assembly, wherein the ice tray defines a drain;
a tank removably coupled with the cabinet, the tank configured to receive liquid from the drain; and
a pump fluidly coupled with the tank and the reservoir, wherein the pump flows liquid from the tank to the reservoir.

2. The refrigerator appliance of claim 1, further comprising:
a controller communicatively coupled with the pump;
a first valve fluidly coupled with the primary conduit, wherein the first valve is communicatively coupled with the controller;
a user input device communicatively coupled with the controller;
an indicator communicatively coupled with the controller; and
a water level sensor disposed within the tank, the water level sensor communicatively coupled with the controller, wherein the water level sensor senses a liquid volume in the tank.

3. The refrigerator appliance of claim 2, wherein the controller is configured to:
generate a first indicia via the indicator in response to the water level sensor sensing the tank holds a maximum volume of water;
determine the tank is empty;
instruct the first valve to allow the primary conduit to flow a first volume of liquid into the reservoir;
activate the pump in response to the water level sensor sensing the tank holds a second volume of liquid; and
deactivate the pump after liquid has flowed through the pump, the reservoir, the ice making assembly, the ice tray, the drain, and the tank for a first duration of time.

4. The refrigerator appliance of claim 3, wherein the controller determines the tank has been emptied and replaced by receiving a first input from the user input device.

5. The refrigerator appliance of claim 3, wherein the controller is further configured to:
generate a second indicia via the indicator in response to the pump deactivating after the first duration of time;
instruct the first valve to allow the primary conduit to flow a second volume of liquid into the reservoir;
determine a cleaning solution is present in the tank; and
activate the pump in response to the water level sensor sensing the tank holds a third volume of liquid; and
deactivate the pump after liquid has flowed through the pump, the reservoir, the ice making assembly, the ice tray, and the tank for a second duration of time.

6. The refrigerator appliance of claim 5, wherein the controller determines the cleaning solution has been added to the tank by receiving a second input from the user input device.

7. The refrigerator appliance of claim 5, wherein the ice making assembly comprises a motor communicatively coupled with the controller, wherein the controller activates the motor during at least one of the first period of time and the second period of time.

8. The refrigerator appliance of claim 1, further comprising a check valve fluidly coupled with the pump, wherein the check valve restricts liquids from flowing from the pump to the tank.

9. The refrigerator appliance of claim 1, wherein the ice tray includes a third valve fluidly coupled with the drain, wherein the third valve selectively closes in response to the tank being removed, and wherein the third valve selectively opens in response to the tank being present.

10. The refrigerator appliance of claim 1, wherein the ice tray comprises:
a first side proximal the ice making assembly; and
a second side distal the ice making assembly, wherein the second side defines the drain.

11. A system of operating an ice making assembly for a refrigerator, the system comprising:
an ice making assembly comprising:
a base coupled with a cabinet of the refrigerator;
an ice forming assembly coupled with the base;
a reservoir fluidly coupled with a primary conduit of the refrigerator, the reservoir fluidly coupled with the ice forming assembly;
an ice tray coupled with the ice forming assembly, wherein the ice tray defines a drain;
a tank removably coupled with the cabinet, the tank configured to receive liquid from the drain;
a pump fluidly coupled with the tank and the reservoir, wherein the pump flows liquid from the tank to the reservoir; and
a controller configured to:
selectively activate the pump to cycle liquid through the reservoir, the ice forming assembly, the ice tray, the drain, the tank, and the pump.

12. The system of claim 11, further comprising:
a first valve fluidly coupled with the primary conduit, wherein the first valve is communicatively coupled with the controller;
a user input device communicatively coupled with the controller;
an indicator communicatively coupled with the controller; and
a water level sensor disposed within the tank, the water level sensor communicatively coupled with the controller, wherein the water level sensor senses a liquid volume in the tank.

13. The system of claim 12, wherein the controller is further configured to:
generate a first indicia via the indicator in response to the water level sensor sensing the tank holds a maximum volume of water;
determine the tank is empty;
instruct the first valve to allow the primary conduit to flow a first volume of liquid into the reservoir;
activate the pump in response to the water level sensor sensing the tank holds a second volume of liquid; and
deactivate the pump after liquid has flowed through the pump, the reservoir, the ice making assembly, the ice tray, the drain, and the tank for a first duration of time.

14. The system of claim 13, wherein the controller determines the tank has been emptied and replaced by receiving a first input from the user input device.

15. The system of claim 13, wherein the controller is further configured to:
generate a second indica via the indicator in response to the pump deactivating after the first duration of time;
instruct the first valve to allow the primary conduit to flow a second volume of liquid into the reservoir;
determine a cleaning solution is present in the tank; and
activate the pump in response to the water level sensor sensing the tank holds a third volume of liquid; and
deactivate the pump after liquid has flowed through the pump, the reservoir, the ice making assembly, the ice tray, and the tank for a second duration of time.

16. The system of claim 15, wherein the controller determines the cleaning solution has been added to the tank by receiving a second input from the user input device.

17. The system of claim 15, wherein the ice making assembly comprises a motor communicatively coupled with the controller, wherein the controller activates the motor during at least one of the first period of time and the second period of time.

18. The system of claim 11, further comprising a check valve fluidly coupled with the pump, wherein the check valve restricts liquids from flowing from the pump to the tank.

19. The system of claim 11, wherein the ice tray includes a third valve fluidly coupled with the drain, wherein the third valve selectively closes in response to the tank being removed, and wherein the third valve selectively opens in response to the tank being present.

20. The system of claim 11, wherein the ice tray comprises:
a first side proximal the ice making assembly; and
a second side distal the ice making assembly, wherein the second side defines the drain.
